(19) United States
(12) Patent Application Publication
(10) Pub. No.: US 2015/0294264 A1
(43) Pub. Date: Oct. 15, 2015

(54) THRESHOLD REVENUE MANAGEMENT WITH LIMITED FORECASTING

(71) Applicant: PROS, Inc., Houston, TX (US)

(72) Inventors: Thomas GORIN, Houston, TX (US); Wei WANG, Houston, TX (US)

(73) Assignee: PROS, Inc., Houston, TX (US)

(21) Appl. No.: 14/250,178

(22) Filed: Apr. 10, 2014

(51) Int. Cl. G06Q 10/08; G06Q 10/02

(52) U.S. Cl. CPC G06Q 10/087; G06Q 10/02

(57) ABSTRACT

Techniques are disclosed for adjusting inventory allocations assigned to system elements published to a reservation and booking system. In particular, inventory allocations assigned to a system element may be adjusted based on deviations from a target utilization level assigned to that element. For example, in the context of an airline pricing and reservation system, a threshold revenue management (RM) system may adjust fare class level (FCL) allocations for a published flight. As disclosed, the threshold RM system may make across-run adjustments when a flight is published in a booking system and across-DCP adjustments after the flight is published. Doing so may both improve revenue as well as help ensure a flight realizes an assigned load factor target at departure.

### BACKGROUND

1. Field

Embodiments of the invention generally relate to revenue management. More specifically, embodiments presented herein provide revenue management techniques that require limited forecasting data to optimize inventory allocations.

2. Description of the Related Art

Operators of commercial transportation and tourism services, e.g., airlines, passenger trains, hotels, cruise ships, rental car fleets, etc., use a variety of metrics to evaluate system performance. For example, airline carriers frequently use load factors—the percentage of seats on a flight occupied by passengers—as a metric for the performance of a flight or market. A carrier may assign a load factor goal to flights between two cities for a given month. The realized load factors for the flights in this market can then be evaluated relative to the load factor goals to measure the performance of the market.

In addition to managing load factors, carriers also use a variety of techniques to help maximize revenue. Broadly, revenue management refers to techniques used to improve revenue by adjusting how fare class inventory is allocated on a set of flights within an airline's network. The goal is to improve revenue using an inventory control strategy that can accurately match customer demand with available products. Revenue management techniques allocate seats to fare classes using a demand forecast. By ensuring inventory is allocated to satisfy forecasted demand for more profitable fare classes (or conversely limiting inventory allocations for lower fare classes, or making lower fares available on low demand flights) an airline can maximize revenue. The realized load factors are a consequence of the bookings which actually occur against the allocated inventory.

As noted, conventional revenue management systems rely on a robust demand forecast to effectively allocate fare class inventory. As a result, these systems are generally packaged in products suited for large airline carriers, which can supply a broad range of historical data used to create an accurate demand forecast. In contrast, for new or discount carriers, the data needed for forecasting may be unavailable, incomplete, or of low quality, e.g., a carrier might not capture historical inventory allocations. The lack of quality data results in forecasting accuracy problems. Further, in terms of demand type, some carriers service a very high percentage of price oriented (priceable) customers, which further distinguishes them from airline carriers with sizable proportions of product oriented (yieldable) customers. Conventional revenue management systems may be unable to effectively improve the revenue of these carriers.

### SUMMARY

One embodiment presented herein includes a method for determining a plurality of inventory allocation thresholds for a first system element. This method may generally include receiving a utilization target for the first system element and identifying a plurality of inventory allocations assigned to a plurality of second system elements and a historical utilization of the plurality of second system elements. This method may also include assigning, to the first system element, one or more inventory allocation thresholds based on the inventory allocations assigned to the plurality of second system elements and a deviation between the historical utilization of the plurality of second system elements and the utilization target.

Other embodiments include, without limitation, a computer-readable medium that includes instructions that enable a processing unit to implement one or more aspects of the disclosed methods as well as a system having a processor, memory, and application programs configured to implement one or more aspects of the disclosed methods.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings. Note, however, the appended drawings illustrate typical embodiments of this invention and are therefore not limiting of its scope, for the invention may admit to other equally effective embodiments.

FIG. 1 illustrates an example computing environment, according to one embodiment.

FIG. 2 further illustrates an across-run component configured to determine booking thresholds for a flight, according to one embodiment.

FIG. 3 illustrates a method for making an across-run adjustment to fare class booking thresholds, according to one embodiment.

FIG. 4 illustrates an across data collection point (across-DCP) component of a revenue management system configured to adjust fare class booking thresholds, according to one embodiment.

FIG. 5 illustrates a method for making an across-DCP adjustment to fare class booking thresholds, according to one embodiment.

FIG. 6 illustrates example booking data used to perform an across-run adjustment to fare class booking thresholds according to one embodiment.

FIG. 7 illustrates example booking data used to perform an across-DCP adjustment to fare class booking thresholds, according to one embodiment.

FIG. 8 illustrates an example computing system configured to adjust fare class booking thresholds, according to one embodiment.

### DETAILED DESCRIPTION

Embodiments of the invention provide techniques for adjusting inventory allocations assigned to system elements published to a reservation and booking system. In particular, inventory allocations assigned to a system element may be adjusted based on deviations between a utilization target assigned to that element and an actual utilization that results from the past inventory allocations. For example, in the context of an airline pricing and reservation system, a threshold revenue management (RM) system may adjust fare class level (FCL) allocations for a published flight. Fare class levels refer to the number of bookings a system operator will accept in a particular fare class. As an example, assume an airline carrier uses four fare class levels, labeled Y, B, M, and H in the order of decreasing fares. Each booking for a flight is associated with one of these four fare class levels. Fare class levels are usually ordered from least restrictive (which correspond to the most expensive fares) to most restrictive (which correspond to the least expensive fares). Also, fare class inventory allocations are usually nested; meaning that inventory made available to one class is also available to higher classes in the structure. For example, if 10 seats are made available to M class exclusively, in a non nested environment, these ten seats could only be booked using an M class fare. In a nested environment, seats can be booked in M class but also in Y and B classes, which are higher in the nested structure.

When publishing a flight in a booking system (typically six months to a year prior to that flight departure), a carrier may assign an initial inventory allocation for the FCLs. As noted, a conventional revenue management system may determine the initial inventory allocation based on forecasted demand for each fare class level. The carrier then accepts bookings for that flight until departure. When the next instance of that flight is published, e.g., the same flight one year later, the carrier may adjust the initial fare class allocations. Of course, fare class allocations may also be adjusted prior to departure. Similarly, a carrier may group certain flights with similar booking characteristics into a flight group and assign (and adjust) inventory allocations based on the realized load factors of departures within the flight group. For example, flights between two cities for one month may provide a model for flights between those cities in a subsequent month. Doing so allows a carrier to avoid having to wait for year-over-year data to evaluate the results achieved by the initial FCL allocations.

In one embodiment, a threshold RM system may be configured to adjust fare class thresholds based on a target load factor assigned to a flight. A fare class “threshold” generally refers to the booked load factor at which a given fare class level is closed from further bookings. The threshold RM system provides a threshold control method that relies on limited forecast data. That is, the threshold RM system can improve revenue for system operators that are unable to collect or retain certain detailed data related to bookings or other customer behavior. Further, in some cases forecast data may not even exist, such as when a carrier enters a new market.

In one embodiment, the threshold RM system assigns fare class inventory allocations based on initial load factor targets and actual load factors realized by a corresponding group of flights which used the same initial load factor target. Thus, the threshold RM system may be deployed by smaller or discount carriers that traditionally have not collected the data needed for conventional demand forecasting. Further, driving revenue management using load factor targets as described herein may improve revenue for discount or smaller carriers serving primarily priceable customer populations more than can be achieved using conventional demand forecasting and revenue management techniques.

In one embodiment, the threshold RM system accounts for both load factor targets assigned to a flight prior to departure and for load factors achieved at departure by a corresponding flight group when adjusting the fare class thresholds. Further, the threshold RM system may also adjust fare class thresholds after a flight is published, but prior to departure, based on the booking counts realized (per FCL) on that flight and an estimate of a booking count needed to achieve the load factor target. To do so, the threshold RM system may adjust fare class thresholds both across flight runs and across data collection points (across-DCPs), as described in greater detail below.

An across-run adjustment is generally a primary, or proactive adjustment, made to fare class thresholds when a flight is published. For example, when a flight is published to a booking and reservation system, the initial fare class thresholds assigned to the new flight may be adjusted based on thresholds assigned to prior runs of that flight (or corresponding flights in a flight group) and the realized load factors that occurred for those flights. The across-run adjustment may use a deviation between a target load factor and historical realized load factors to adjust the fare class thresholds assigned to the new flight.

An across data collection point (across-DCP) adjustment is a secondary, or reactive adjustment, that dynamically considers real time booking information to tighten or loosen the fare class inventory allocations. Doing so may both improve revenue as well as help a flight realize load factor targets. An across-DCP adjustment may use the deviation between the actual booking counts of a flight published (but not yet departed) at a DCP and an average booking count (or booked load factor) achieved by flights in the same flight group at the same DCP. As described below, the booking count of each historical flight may be scaled based on the target load factor and the realized load factor of that flight. From this, an average, scaled booking count may be used to determine an across-DCP adjustment. Across-DCP adjustments may be made periodically any time in-between a flight being published in the booking system and flight departure. For example, assume a carrier publishes a flight a year in advance of the departure. In such a case, an across-DCP adjustment could be made monthly for the first three months, weekly for the next six months, and daily for the last three months. Of course, a carrier may tailor when across-DCP adjustments occur using any suitable schedule.

Note, embodiments of the invention are described below using an airline passenger booking system as a reference example of a system where individual system elements (e.g., a flight) are assigned inventory allocations (e.g., fare class thresholds) based on element utilization data (e.g., based on realized load factors that occurred on prior runs of flights in a corresponding flight group) as well as to adjust the assigned inventory allocations at specified points in time. That is, an airline passenger booking system is used as a reference example to describe both across-run and across-DCP adjustments to fare class inventory allocations. Of course, one of ordinary skill in the art will recognize that this example embodiment may be adapted for a variety of other systems where inventory or pricing allocations available for system elements are adjusted either across-run (i.e., when a new system element is published and made available for reservation) or across-DCP (i.e., between publication and expiration of a system element).

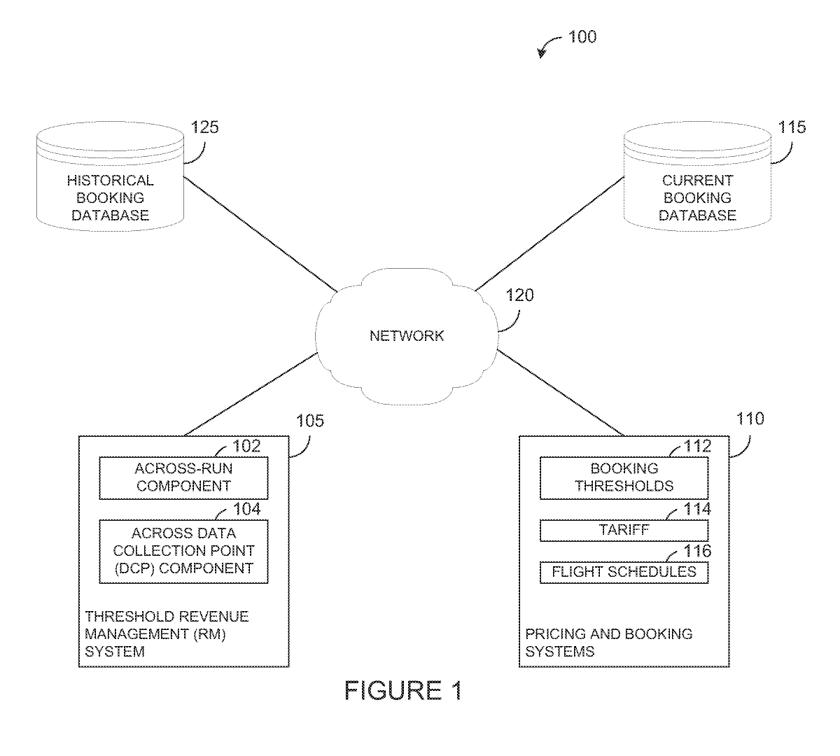

FIG. 1 illustrates an example computing environment, according to one embodiment. As shown, the computing environment 100 includes a threshold revenue management (RM) system 105, pricing and booking systems 110, current booking database 115, and historical booking database 125, each connected to a network 120.

The pricing and booking systems 110 include booking thresholds 112, tariff 114, and flight schedules 116. The pricing and booking systems 110 generally correspond to computer systems and related infrastructure used to determine availability and pricing for a flight departure published in the flight schedules 116. That is, the pricing and booking systems 110 generally allow passengers (and airline employees) to book inventory on a given flight by reserving seats in a given booking class for a price determined by the pricing and booking systems 110, according to booking class availability and the fare tariff. To do so, the pricing and booking systems 110 may compare current booking data for a given flight to thresholds 112 to determine what fare class levels (FCLs) are available for that flight. As noted, booking thresholds 112 generally indicate load factors at which a given fare class level is closed from further bookings. Once FCL inventory is identified, the pricing and booking systems 110 determine what fares are available for booking using tariff 114. As new bookings occur, current booking database 115 is updated, up until flight departure, at which point realized load factor levels may be stored in historical booking database 125.

Additionally, the pricing and booking systems 110 allow a system operator to understand at any given time the then currently booked load factor for any given flight (prior to departure). The current bookings and corresponding load factors may be stored in the current booking database 115 and historical load factors for an individual flight (or a group of flights in a flight group) may be stored in historical booking database 125.

In one embodiment, the threshold RM system 105 generally corresponds to computer systems and related infrastructure used to determine and adjust booking thresholds 112 by making both across-run adjustments to new flights added to the flight schedule 116 and by making across-DCP adjustments between a flight being published and flight departure. As shown, the threshold RM system 105 includes an across-run component 102 and an across-DCP component 104. The across-run component 102 provides computing applications configured to determine an initial set of booking thresholds 112 for a flight at the time that flight is published in the flight schedules 116. In one embodiment, the initial thresholds may be determined using a load factor target assigned to the new flight and deviation of the load factor target from an average load factor realized in prior runs of that flight (or corresponding flight group). The target load factor may be assigned by an analyst but may also be assigned by propagating a load factor goal for a market to each flight in the market. Note, a market generally refers to a group of flights between two cities for a given period, such as one month. Examples of propagating a market load factor goal are described in commonly owned patent application titled “Method to Propagate a System Level Utilization Goal to Individual System Elements,” U.S. application Ser. No. 14/249,963 filed on filed on Apr. 10, 2014.

Once published, the across-DCP component 104 may be used to adjust the initial booking thresholds assigned by the across-run component 102 prior to flight departure. In one embodiment, the across-DCP component 104 may adjust the booking thresholds based on booked load factors and deviations from an estimated booked load factor needed to help realize the target load factor prior to flight departure, relative to the current data collection point. For example, the across-DCP component 104 may reduce the booking thresholds of FCLs on a flight that exceeds the bookings needed to reach the target load factor at a given data collection point. Doing so may help increase revenue by reducing the availability of lower yield fares and pushing demand to higher yield fares, while preserving the bookings needed to achieve factor load factor target at departure. Conversely, the across-DCP component 104 may increase booking thresholds for FCLs on a flight with booking counts which lag behind an estimated booking count needed at given data collection point to realize the load factor target at flight departure. Doing so may help accelerate the booking rate for that flight prior to departure. As noted, the points at which the across-DCP component 104 evaluates current bookings on a given flight may be tailored to suit the needs of a particular case.

Additional examples of techniques for adjusting FCL thresholds performed by the across-run component 102 and the across-DCP component 104 are described below. Also note, while illustrated in FIG. 1 as combined pricing and booking systems 110, threshold RM system 105, current booking database 115, and historical booking database 125, one of ordinary skill in the art will recognize that airline (and other system) reservation and pricing applications are typically hosted on large numbers of computing servers hosted within one or more data centers. Further, the pricing and booking systems 110, threshold RM system 105, current booking database 115, and historical booking database 125 are included to be representative of both physical computing systems hosting the described applications as well as virtual machine instances executing these applications within a computing cloud. Additionally, while shown together, pricing and booking systems 110 may be applications hosted on separate computing systems. Network 120 may correspond to a local network segment at a data center connecting systems 105, 110, 115, and 125 as well as networks connecting these systems across data centers or across cloud hosting providers, including the internet.

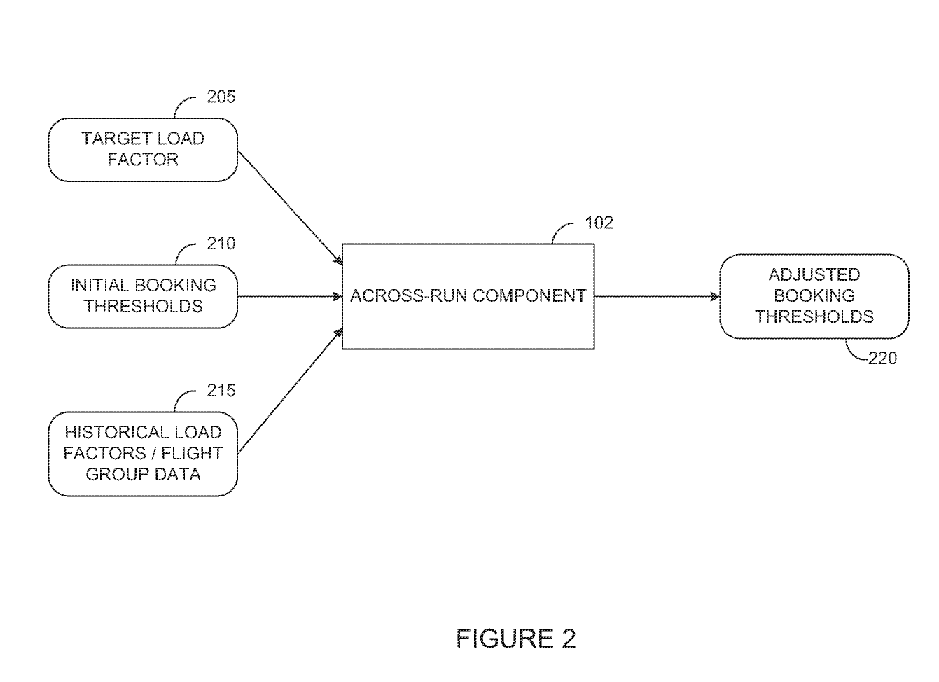

FIG. 2 further illustrates an across-run component 102 of a threshold RM management system configured to determine booking thresholds for a flight run being published in a booking and pricing system, according to one embodiment. As shown, the across-run component 102 receives a target load factor 205, initial booking thresholds 210, and historical load factors 215. The target load factor 205 generally corresponds to a load factor goal a system operator desires for a flight at departure. As noted, the target load factor may be assigned at the discretion of an analyst or propagated from a load factor goal assigned to a month/market (e.g. flights from Houston-Chicago for the month of April). The initial booking thresholds 210 generally correspond to booking thresholds assigned to a set of flights within a common market segmentation group. Market segmentation generally refers to scientific methods for grouping flights that exhibit similar performance characteristics, such as similar passenger demand and booking curves. Historical load factors 215 correspond to the actual load factors realized by departed fights in the flight group, which were initially published for booking with the initial booking thresholds 210. From these inputs, the across-run component 102 generates adjusted booking thresholds 220 for one or more of the FCLs associated with the new flight run.

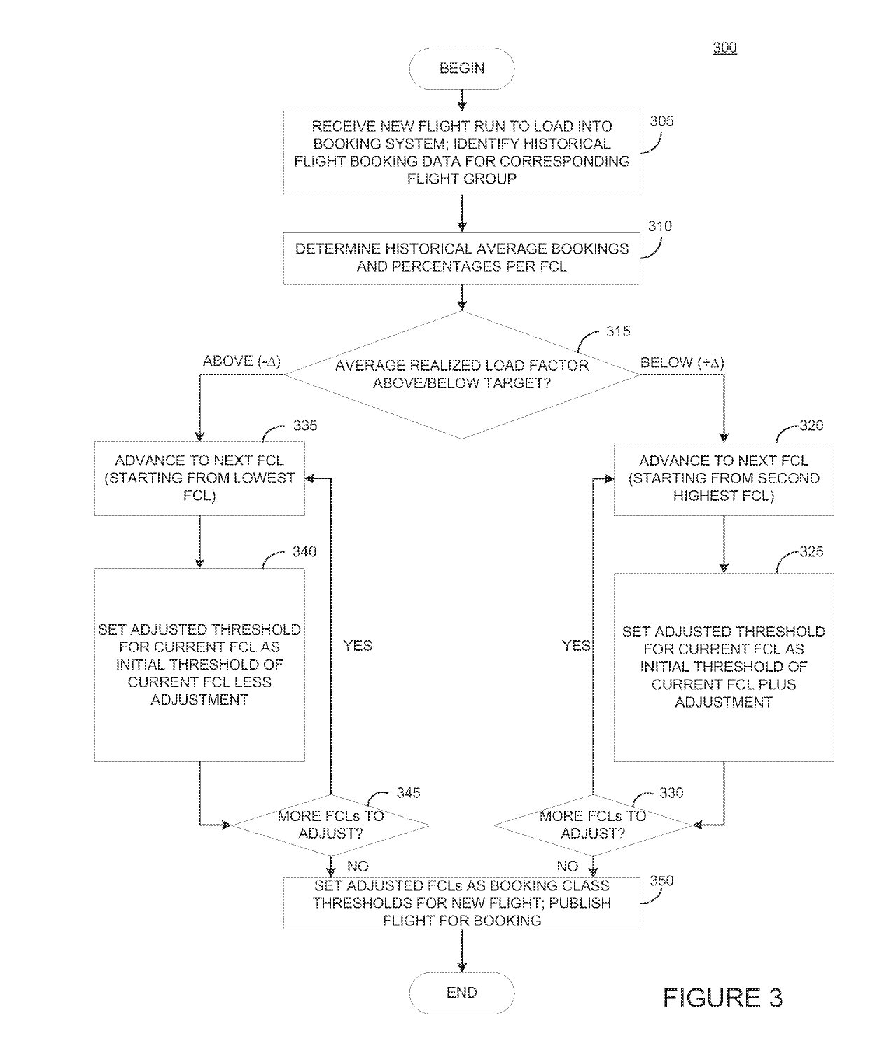

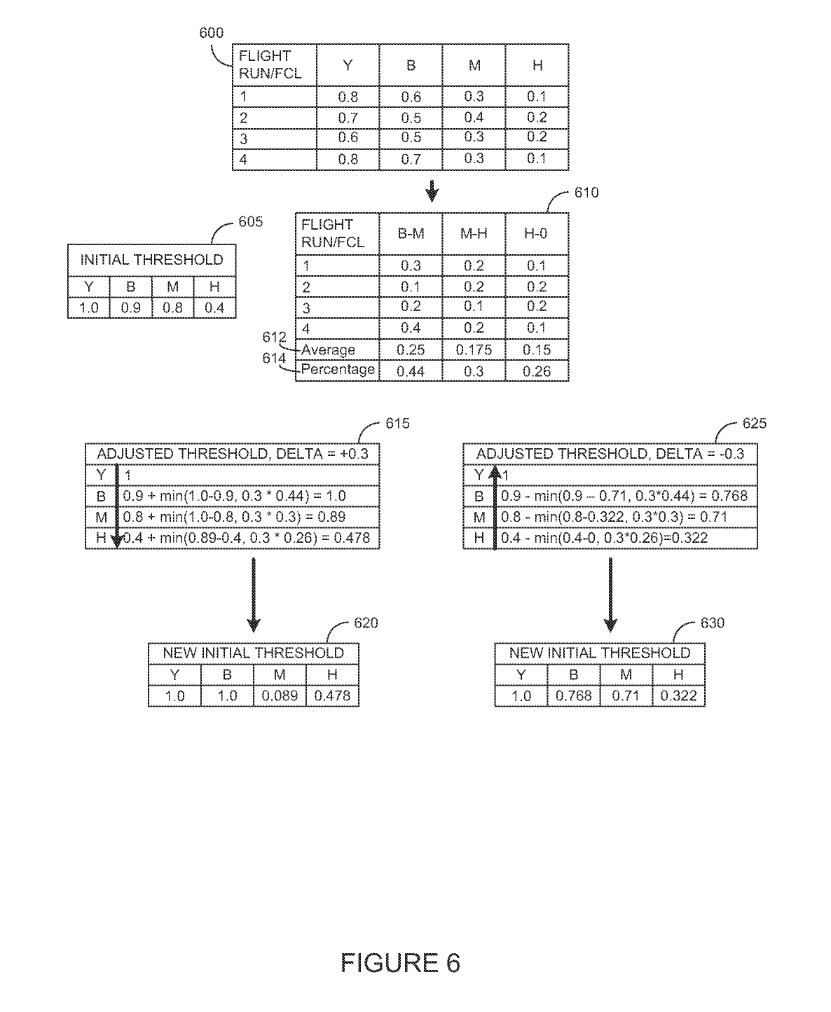

For example, FIG. 3 illustrates a method 300 for making an across-run adjustment to fare class booking thresholds, according to one embodiment. The method 300 is described relative to a set of example data presented in FIG. 6.

As shown, method 300 begins at step 305, where the across-run component identifies a new flight to be loaded into a pricing and booking system. Once identified, the across-run component retrieves historical load factor data for flights in the same flight group of the new flight. The across-run component may also retrieve the initial FCL booking thresholds assigned to the flights in the flight group. For example, table 600 of FIG. 6 shows FCL load factors for four flights in a flight group. Table 600 shows the historical load factors in a nested format, where the realized load factor of each FCL is the sum of its own load factor and the load factors of any lower FCLs. Thus, in table 600, the load factor for the Y fare class represents the total load factor of the flight itself. In this example, flight 1 had an overall load factor of 0.8, the B fare class (and below) had a 0.6 load factor, the M fare class (and below) had a 0.3 load factor, and the H fare class had a 0.1 load factor. Table 605 shows the initial FCL thresholds assigned to FCLs in the flight group of flights 1-4. Thus, based on an initial threshold of 0.9 for the B fare class (meaning 90% of the inventory on flights in this flight group could be booked in B class or below), flights 1-4 realized booked load factors in the B fare class of 0.6, 0.5, 0.5, and 0.7, respectively.

In contrast to the nested load factors shown in table 600, table 610 shows the actual booked load factor achieved by each of the B, M, and H fare classes in the flight group of flights 1-4. For example, the actual load factor in the B fare class of flight 1 was 0.3.

Referring again to method 300, at step 310, the across-run component determines an average fare class level booking percentage for each flight in the flight group. Row 612 of table 610 shows the average load factors, per FCL, for the flights in the flight group. Row 614 shows the relative percentages of bookings made in each fare class level, based on the average load factors of flights in the flight group (per fare class). For example, for the B fare class, the percentage is calculated as follows:

$$\frac{0.25}{0.25 + 0.175 + 0.15} = 0.44 \qquad ( eq . 1 )$$

Percentages for the M and H fare classes shown in row 614 are computed in a similar manner.

At step 315, the across-run component adjusts the FCL thresholds for the new flight entering the system based on whether the average realized load factor of the flight group was above or below the target load factor. In this example, a positive difference (delta) between the target load factor and average realized load factor corresponds to a flight group that did not satisfy the target load factor and a negative difference (delta) corresponds to a flight group that exceeded the target load factor at departure.

If the average realized load factor for the flight group is below the target load factor (a positive delta), then the across-run component adjusts the initial thresholds for the new flight by increasing the thresholds of all classes except the top fare class in decreasing order (steps 320-330). Note, the top fare class—Y—is automatically assigned a threshold value of 1.0. A variety of approaches can be used to determine the actual adjustments made to the FCL thresholds nested below the Y fare class level. As shown, at step 320, the across-run component begins with the second highest FCL and iterates until reaching the last or lowest FCL (H class in the present example). In the embodiment shown in FIG. 3, an adjustment made to a current FCL is used as an input to the next FCL on each pass through steps 320-330. At step 325, the across run component may determine an adjusted threshold for the current FCL (beginning with the B fare class in this example) as follows:

Inital FCL Threshold+min((next higher class threshold−intial threshold of current class),delta*relative percentage of FCL) (eq. 2)

Table 615 shows the results of the iteration of steps 320-330 for the load factor data of table 610, assuming a load factor delta of +0.3. As shown, the adjustment to M class is determined as:

M=0.8+min(1.0−0.8,0.3*0.3)=0.89 (eq. 3)

In this example, the adjustment to M depends, in part, on the adjusted value of B made during the first iteration of steps 320-330. Further, the adjusted value of M (0.89) is then used to determine an adjustment to H. Table 620 shows the new FCL thresholds determined using the data shown in table 610 and adjusted using equation 2. These thresholds are set as the booking class thresholds to use in determining fare class availability for bookings on the flight being published (step 350). To summarize, in the case where the average realized load factors of the flight group did not reach the target load factor, equation 2 will increase the availability of all fare classes for the new flight entering the system (except the top fare class), given the relative booking percentage (illustrated in equation 1) of classes with a positive booking percentage (i.e., ones which are not zero). Doing so is expected to result in improved revenue when the new flight departs, while still achieving the load factor target at departure.

Conversely, if the average realized load factors for the flight group is above the target load factor (a negative delta), then the across-run component adjusts the initial thresholds for the new flight by decreasing the thresholds of the FCLs (except the top one). While a variety of approaches can be used to determine the actual adjustments made to the FCL thresholds, in one embodiment, the across-run component begins at the lowest or last FCL (step 335) and iterates until reaching the second highest FCL (B class in the present example). Again, the allocation to the top FCL, Y is automatically set to 1.0. In the embodiment of method 300, an adjustment made to a current FCL is used as an input to the next FCL on each pass through steps 335-345. At step 340, the across-run component may determine an adjusted threshold for a current FCL (beginning with the H fare class in our example) as follows:

Initial FCL Threshold−min(initial threshold of current class−adjusted threshold of next lower class,(delta*relative precentage of current class)) (eq. 4)

Table 630 shows the results of the iteration of steps 335-345 for the load factor data of table 610, assuming a load factor delta of −0.3. As shown, the adjustment to M class is determined as:

M=0.8+min(0.8−0.322,0.3*0.3)=0.71 (eq. 5)

In this example, the adjustment to M depends, in part, on the adjusted value of H made during the first iteration of steps 335-345. Further, the adjusted value of M (0.71) is then used to determine an adjustment to B. Table 630 shows the new FCL thresholds determined using the data shown in table 610 and adjusted using equation 4. These thresholds are set as the booking class thresholds to use in determining fare class availability for bookings on the flight being published (step 350). Again, in the case where the average realized load factors of the flight group exceeded the target load factor equation 4 will decrease the availability of fare classes for the new flight (other than Y), given the relative booking percentage (illustrated in equation 1) of classes with a positive booking percentage (i.e., ones which are not zero). Doing so is expected to result in improved revenue when the new flight departs, while helping to achieve the load factor target at departure. Note, for convenience, the example described above assumes that each flight in a flight group has the same load factor target when calculating the difference between that load factor target and the average realized load factor. In practice, the average realized load factor may be adjusted to account for different load factor targets on flights within the flight group.

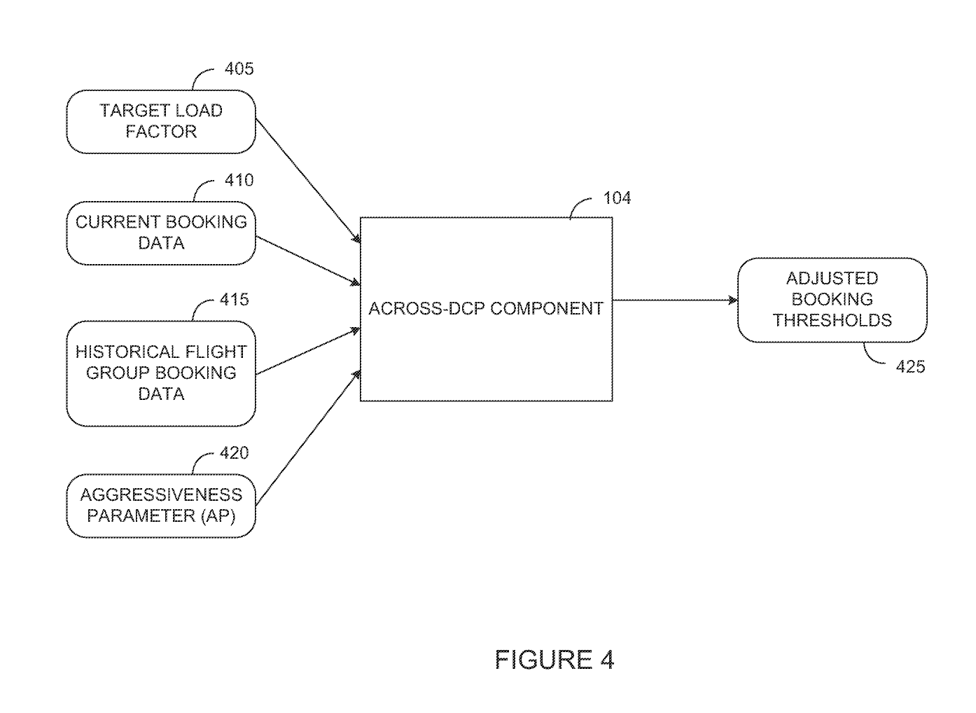

FIG. 4 further illustrates an across-DCP component 104 of a threshold RM management system configured to determine booking thresholds for a flight run being published in a booking and pricing system, according to one embodiment. As shown, the across-DCP component 104 receives a target load factor 405, current booking data 410, historical booking data 415, and an aggressiveness parameter 420. The target load factor 405 generally corresponds to a load factor goal a system operator has assigned to a flight. Historical booking data 415 corresponds to the actual booking levels for that flight group achieved at a corresponding data collection point (DCP). The aggressiveness parameter is used to tune how much the across-DCP component 104 will dynamically change the threshold of a given FCL. From these inputs, the across-DCP component 104 generates adjusted booking thresholds 425 for the FCLs associated with a flight run.

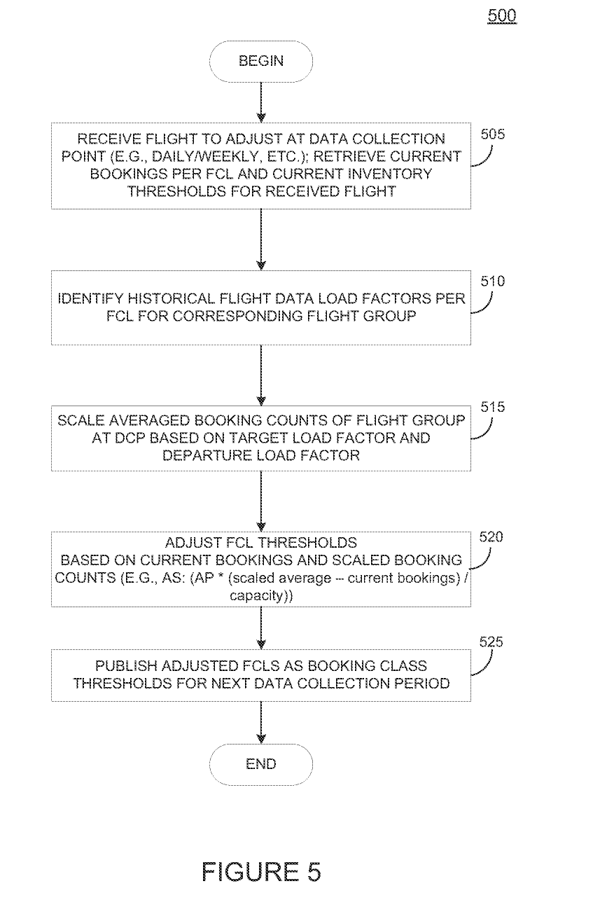

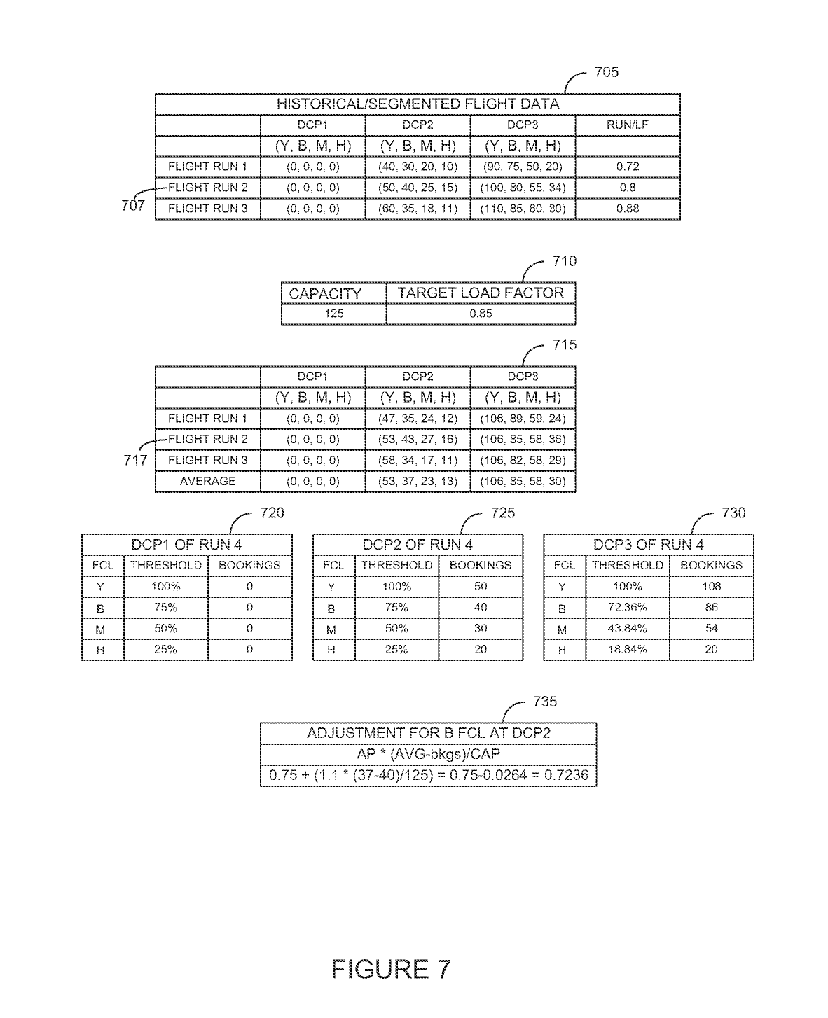

For example, FIG. 5 illustrates a method 500 for performing an across-DCP adjustment to fare class booking thresholds, according to one embodiment. The across-DCP adjustment adjusts thresholds based on deviation of a current booking count and an estimate of what the bookings are needed at that DCP in order to realize the target load factor at flight departure. Stated differently, the estimated booking counts at each DCP form a target booking curve. For a given DCP, the FCLs may be adjusted based on a deviation between the booking curve of the flight and the target curve generated from the booking counts of the flights in the flight group. The method 500 is described relative to a set of example data presented in FIG. 7. Note, for convenience, the example described below assumes that the historical flights each have the same capacity. In practice, the booking counts of historical flights may be adjusted to account for differences in capacity on each flight within a flight group.

As shown, method 500 begins at step 505, where the across-DCP component identifies a flight that has reached a data collection point. Once identified, the across-DCP component retrieves current booking counts, per FCL, along with the current inventory thresholds of the identified flight. At step 510, the across-DCP component retrieves historical flight data for the flight group corresponding to the flight identified at step 505. Specifically, the across-DCP component may retrieve booking counts achieved by the flights in the flight group at the same DCP and retrieve the load factors realized by these flights at departure. For example, table 705 of FIG. 7 shows a set of booking counts, per FCL, for a flight group at three data collection points, labeled DCP1, DCP2 and DCP3. DCP1 corresponds to a point when the flight is first published in a flight schedule, DCP2 correspond to a subsequent point between publishing and departure, and DCP3 corresponds to the booking levels at flight departure. Additionally, table 705 shows the load factors realized by flights 1, 2, and 3 at flight departure. Table 710 shows a capacity (125) and target load factor (0.85) for the flights in this flight group.

Referring again to method 500, at step 515, the across-DCP component scales the booking counts for the flights in the flight group based on the target load factor. In particular, the across-DCP component scales the DCP booking counts to a level that matches a booking level that would result in the flight achieving the target load factors at departure. In one embodiment, the scaling factor is determined as follows:

$$scaling factor = \frac{target load factor}{departure load factor} \qquad ( eq . 6 )$$

For example, consider the historical flight data for flight 2 (row 707 of table 705). At DCP2, flight 2 had nested booking counts of (50, 40, 25, 15) in the (Y, B, M, H) FCLs. The scaled booking counts of (53, 43, 27, 16) may be determined using the scaling factor of (0.85/0.8)=1.0625. Again this example assumes each historical flight has the same capacity, otherwise adjustments may be made to determine the appropriate scaled booking counts to account for varying capacity among the historical flights. After applying this scaling to each flight in the historical group and averaging out the resulting scaled bookings by class, it can be seen that on average, a flight in this group should have a booking count of (53, 37, 23, 13) in each of the four classes of service (Y, B, M, H) at DCP2. In particular, B class should have an average of 37 bookings at DCP2. Based on the average booking counts, the across-DCP component can adjust an FCL to “loosen” or “tighten” fare class availability, depending on whether the bookings exceed or lag behind the averages determined for that DCP.

At step 520, the across-DCP component adjusts each FCL threshold based on the bookings at a current DCP and the bookings in the scaled historical average at that DCP for the flight group. While a variety of approaches can be used to determine the actual adjustments made to the FCL thresholds at a DCP, in one embodiment, the across-DCP component adjusts the FCL thresholds as follows:

AP*(scaled average−current bookings)/capacity (eq. 7)

The aggressiveness parameter (AP) corresponds to an aggressiveness value, where value of 1.0 is neutral and values exceeding 1.0 will result in more aggressive adjustments and values below 1.0 will result in less aggressive adjustments. Tables 720, 725, and 730, show the adjustments made to flight 4 at DCP1, DCP2, and DCP3 respectively. As shown in table 720, the thresholds for flight 4 are unchanged at DCP1, i.e., when flight 4 is initially published in the flight schedule. However, at DCP2 the FCLs are adjusted based on the actual bookings that have occurred between DCP1 and DCP2.

Consider the initial booking threshold for the B fare class (0.75). In the example of table 725, at DCP2, flight 4 has the following booking count (50, 40, 30, 20). However, the average booking count for the flight group, scaled to meet the load factor target in the flight group has a booking count of (53, 37, 23, 13). Thus, flight 4 is three seats behind the average predicted as need to achieve the load factor target (50 seats booked in Y, versus an average of 53 for flights in the flight group at DCP2). At the same time, bookings in B class and M class have exceeded the predicted averages—40 booked versus 37 predicted in B class and 30 booked versus 23 predicted for M class. Table 735 shows the adjustment made to the B fare class at using equation 6 (using an aggressiveness parameter of 1.1). As shown, the resulting adjustment to the B fare class is to reduce the initial threshold of 0.75 by a value of 0.0264. This results in an adjusted B fare class threshold of 0.7236. This cutoff for B class is then used between DCP2 and DCP3. At step 525, the across-DCP component sets the FCL thresholds determined at step 520 for the flight being evaluated. These thresholds remain in effect until the next DCP. Table 730 shows the adjusted fare class for B, as well as the adjusted fare classes for M and H classes of service based on the booking counts shown in table 720 and the historical averages at DCP2. Note, this methodology could lead to inversions in thresholds by class, i.e., where a higher fare class has lower threshold than one below it. In a nesting environment, such inversions are typically prohibited from occurring. Accordingly, in one embodiment, the adjusted FCLs may be validated and adjusted should any inversions occur.

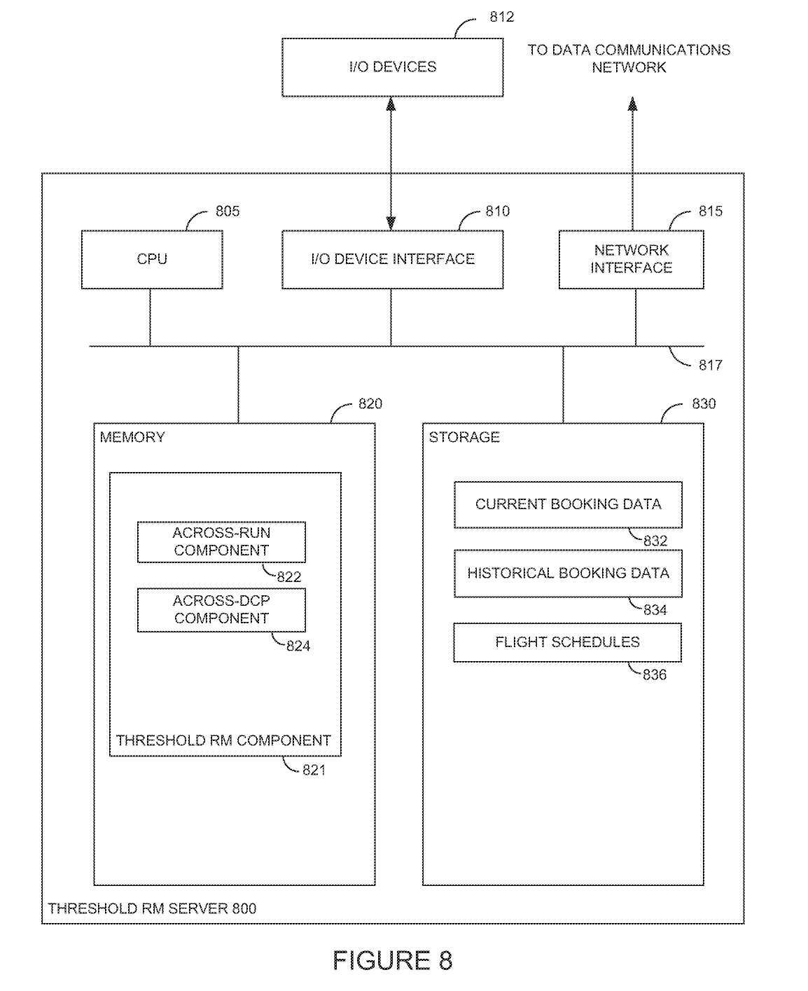

FIG. 8 illustrates an example computing system 800 configured to adjust fare class booking thresholds based on historical load factors, according to one embodiment. As shown, the computing system 800 includes, without limitation, a central processing unit (CPU) 805, a network interface 815, a memory 820, and storage 830, each connected to a bus 817. The computing system 800 may also include an I/O device interface 810 connecting I/O devices 812 (e.g., keyboard, mouse, and display devices) to the computing system 800. Further, in context of this disclosure, the computing elements shown in computing system 800 may correspond to a physical computing system (e.g., a system in a data center) or may be a virtual computing instance executing within a computing cloud accessed using a remote sell.

The CPU 805 retrieves and executes programming instructions stored in the memory 820 as well as stores and retrieves application data residing in the memory 830. The interconnect 817 is used to transmit programming instructions and application data between the CPU 805, I/O devices interface 810, storage 830, network interface 815, and memory 820. Note, CPU 805 is included to be representative of a single CPU, multiple CPUs, a single CPU having multiple processing cores, and the like. And the memory 820 is generally included to be representative of a random access memory. The storage 830 may be a disk drive or solid state storage device storage device. Although shown as a single unit, the storage 830 may be a combination of fixed and/or removable storage devices, such as fixed disc drives, removable memory cards, or optical storage, network attached storage (NAS), or a storage area-network (SAN).

Illustratively, the memory 820 includes a threshold RM component 821, which provides an across-run component 822, and across DCP component 824. The storage 830 includes current and historical booking data 832, 824 and flight schedules 836. As described, the threshold RM component 821, across-run component 822, and across DCP component 824 may provide one or more application programs configured to assign initial FCL thresholds to flights based on historical load factors and a target load factor, as well as to dynamically adjust these assigned thresholds at data collection points based on the actual bookings a given flight. To do so, the threshold RM component 821 may use the current booking data 832, historical booking data 824, flight schedules 836, and other input data to determine FCL thresholds using the techniques set forth above.

Advantageously, embodiments of the invention provide techniques for adjusting inventory allocations assigned to system elements published to a reservation and booking system. In particular, inventory allocations assigned to a system element may be adjusted based on deviations from an element utilization target assigned to that element. For example, in the context of an airline pricing and reservation system, a threshold revenue management (RM) system may adjust fare class level (FCL) allocations for a published flight. As described, the threshold RM system may make across-run adjustments when a flight is published in a booking system and across-DCP adjustments after the flight is published.

In the preceding, reference is made to embodiments of the invention. However, the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Other examples a computer readable storage medium include: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the current context, a computer readable storage medium may be any tangible medium that can contain, or store a program for use by or in connection with an instruction execution system, apparatus or device.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of code, which comprises one or more executable instructions for implementing the specified logical function(s). In some alternative implementations the functions noted in the block may occur out of the order noted in the figures. For example, two blocks shown in succession may, in fact, be executed substantially concurrently, or the blocks may sometimes be executed in the reverse order, depending upon the functionality involved. Each block of the block diagrams and/or flowchart illustrations, and combinations of blocks in the block diagrams and/or flowchart illustrations can be implemented by special-purpose hardware-based systems that perform the specified functions or acts, or combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources. A user can access any of the resources that reside in the cloud at any time, and from anywhere across the Internet. In context of the present invention, the threshold RM system may provide a cloud based application used by an analyst to make both across-run and across-DCP adjustments to an FCL for a given flight. Doing so may both loosen and tighten fare class inventory in order to achieve load factor targets and maximize revenue.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A computer-implemented method for determining a plurality of inventory allocation thresholds for a first system element, the method comprising:
receiving a utilization target for the first system element;
identifying a plurality of inventory allocations assigned to a plurality of second system elements and a historical utilization of the plurality of second system elements;
assigning, to the first system element, one or more inventory allocation thresholds based on the inventory allocations assigned to the plurality of second system elements and a deviation between the historical utilization of the plurality of second system elements and the utilization target.

2. The method of claim 1, further comprising, publishing the first system element to a booking and reservation system, wherein inventory associated with the inventory allocations is made available for booking based on the assigned inventory allocations.

3. The method of claim 2, further comprising:
at a predefined point following the publication of the first system element to the booking and reservation system:
identifying a then current booking count for each of the one or more assigned inventory allocations;
determining a variance between the then current booking count for a first one of the inventory allocations and a corresponding average booking count for plurality of second system elements at a corresponding predefined point; and
adjusting the first inventory allocation based on the determined variance.

4. The method of claim 2, wherein the first system element is a scheduled passenger airline flight departure.

5. The method of claim 4, wherein the inventory allocations thresholds correspond to a plurality of nested fare class levels.

6. The method of claim 4, wherein each of the second system elements corresponds to a flight in a flight group.

7. The method of claim 1, wherein the deviation between the historical utilization of the plurality of second system elements and the utilization target indicates that an average historical utilization of the plurality of second system elements fell below the utilization target, and wherein the inventory allocation thresholds assigned to the first system element increases one or more of the assigned inventory allocation thresholds relative to the inventory allocations assigned to the plurality of second system elements.

8. The method of claim 1, wherein the deviation between the historical utilization of the plurality of second system elements and the utilization target indicates that an average historical utilization of the plurality of second system elements exceeded the utilization target, and wherein the inventory allocation thresholds assigned to the first system element reduces one or more of the assigned inventory allocation thresholds relative to the inventory allocations assigned to the plurality of the second system elements.

9. A computer-readable storage medium storing instructions, which, when executed on a processor, perform an operation for determining a plurality of inventory allocation thresholds for a first system element, the operation comprising:
receiving a utilization target for the first system element;
identifying a plurality of inventory allocations assigned to a plurality of second system elements and a historical utilization of the plurality of second system elements;
assigning, to the first system element, one or more inventory allocation thresholds based on the inventory allocations assigned to the plurality of second system elements and a deviation between the historical utilization of the plurality of second system elements and the utilization target.

10. The computer-readable storage medium of claim 9, wherein the operation further comprises, publishing the first system element to a booking and reservation system, wherein inventory associated with the inventory allocations is made available for booking based on the assigned inventory allocations.

11. The computer-readable storage medium of claim 10, wherein the operation further comprises:
at a predefined point following the publication of the first system element to the booking and reservation system:
identifying a then current booking count for each of the one or more assigned inventory allocations;
determining a variance between the then current booking count for a first one of the inventory allocations and a corresponding average booking count for plurality of second system elements at a corresponding predefined point; and
adjusting the first inventory allocation based on the determined variance.

12. The computer-readable storage medium of claim 10, wherein the first system element is a scheduled passenger airline flight departure.

13. The computer-readable storage medium of claim 12, wherein the inventory allocations thresholds correspond to a plurality of nested fare class levels.

14. The computer-readable storage medium of claim 12, wherein each of the second system elements corresponds to a flight in a flight group.

15. The computer-readable storage medium of claim 9, wherein the deviation between the historical utilization of the plurality of second system elements and the utilization target of the first system element indicates that an average historical utilization of the plurality of second system elements fell below the utilization target, and wherein the inventory allocation thresholds assigned to the first system element increases one or more of the assigned inventory allocation thresholds relative to the inventory allocations assigned to the plurality of second system elements.

16. The computer-readable storage medium of claim 9, wherein the deviation between the historical utilization of the plurality of second system elements and the utilization target of the first system element indicates that an average historical utilization of the plurality of second system elements exceeded the utilization target, and wherein the inventory allocation thresholds assigned to the first system element reduces one or more of the assigned inventory allocation thresholds relative to the inventory allocations assigned to the plurality of the second system elements.

17. An apparatus, comprising:
a processor; and
a memory hosting an application, which, when executed on the processor, perform an operation for determining a plurality of inventory allocation thresholds for a first system element, the operation comprising:
receiving a utilization target for the first system element,
identifying a plurality of inventory allocations assigned to a plurality of second system elements and a historical utilization of the plurality of second system elements, and
assigning, to the first system element, one or more inventory allocation thresholds based on the inventory allocations assigned to the plurality of second system elements and a deviation between the historical utilization of the plurality of second system elements and the utilization target.

18. The apparatus of claim 17, wherein the operation further comprises, publishing the first system element to a booking and reservation system, wherein inventory associated with the inventory allocations is made available for booking based on the assigned inventory allocations.

19. The apparatus of claim 18, wherein the operation further comprises:
at a predefined point following the publication of the first system element to the booking and reservation system:
identifying a then current booking count for each of the one or more assigned inventory allocations;
determining a variance between the then current booking count for a first one of the inventory allocations and a corresponding average booking count for plurality of second system elements at a corresponding predefined point; and
adjusting the first inventory allocation based on the determined variance.

20. The apparatus of claim 18, wherein the first system element is a scheduled passenger airline flight departure.

21. The apparatus of claim 20, wherein the inventory allocations thresholds correspond to a plurality of nested fare class levels.

22. The apparatus of claim 20, wherein each of the second system elements corresponds to a flight in a flight group.

23. The apparatus of claim 17, wherein the deviation between the historical utilization of the plurality of second system elements and the utilization target indicates that an average historical utilization of the plurality of second system elements fell below the utilization target, and wherein the inventory allocation thresholds assigned to the first system element increases one or more of the assigned inventory allocation thresholds relative to the inventory allocations assigned to the plurality of second system elements.

24. The apparatus of claim 17, wherein the deviation between the historical utilization of the plurality of second system elements and the utilization target indicates that an average historical utilization of the plurality of second system elements exceeded the utilization target, and wherein the inventory allocation thresholds assigned to the first system element reduces one or more of the assigned inventory allocation thresholds relative to the inventory allocations assigned to the plurality of the second system elements.
